(19) United States
(12) Patent Application Publication
(10) Pub. No.: US 2012/0128850 A1
(43) Pub. Date: May 24, 2012

(54) FORTIFYING NON-FAT FOOD PRODUCTS WITH POLYUNSATURATED FATTY ACIDS

(75) Inventors: Suzy Xiaoqing Zeng, Louisville, CO (US); Georgia A. Anderson, Longmont, CO (US); Jesus Ruben Abril, Westminster, CO (US); Wei Wang-Nolan, Ellicott City, MD (US)

(73) Assignees: Martek Biosciences Corporation, Columbia, MD (US); Whitewave Services, Inc., Dallas, TX (US)

(21) Appl. No.: 13/036,951

(22) Filed: Feb. 28, 2011

Related U.S. Application Data
(60) Provisional application No. 61/417,043, filed on Nov. 24, 2010.

(51) Int. Cl. C11B 5/00; A23C 9/00; A23D 9/00; A23C 19/00

(52) U.S. Cl. 426/541; 426/582; 426/583; 426/585; 426/601

(57) ABSTRACT

According to one embodiment, a food product comprises a non-fat base, one or more polyunsaturated fatty acids, and one or more stabilizing ingredients. The stabilizing ingredients are selected to reduce the rate at which the polyunsaturated fatty acids oxidize in the non-fat base. At least one of the one or more stabilizing ingredients comprises a protein, a lipid, or a protein-and-lipid combination.

### RELATED APPLICATIONS

This application claims priority to U.S. Provisional Application No. 61/417,043 entitled “Fortifying Non-Fat Food Products with Omega Fatty Acids,” filed Nov. 24, 2010.

### TECHNICAL FIELD OF THE DISCLOSURE

This invention relates in general to non-fat food products and more particularly to fortifying non-fat food products with polyunsaturated fatty acids.

### BACKGROUND

Polyunsaturated fatty acids (PUFAs) refer to a family of fatty acids that naturally occur in certain fish, leafy green vegetables, and vegetable oils. Polyunsaturated fatty acids can include a carbon chain comprising eighteen or more carbon atoms and two or more double bonds. Examples of polyunsaturated fatty acids include omega fatty acids, such as omega-3 fatty acids (e.g., docosahexaenoic acid (DHA), docosapentaenoic acid (n-3) (DPAn-3), stearidonic acid (SDA), linolenic acid (LNA), and alpha linoleic acid (ALA), and eicosapentaenoic acid (EPA)), and omega-6 fatty acids (e.g., arachidonic acid (ARA), docosapentaenoic acid (n-6) (DPAn-6), linoleic acid (LA), gamma linolenic acid (GLA), and dihomo gamma linolenic acid (n-6)). Research suggests that consuming certain polyunsaturated fatty acids can provide health benefits including possibly lowering the risk of heart disease. Accordingly, polyunsaturated fatty acids can be fortified into food products to impart health benefits. Fortifying certain non-fat food products with polyunsaturated fatty acids can tend to affect the flavor of the non-fat food product over time. For example, fortifying the non-fat food product with DHA or EPA can cause the non-fat food product to develop fish flavors over time, and fortifying the non-fat food product with ARA can cause the non-fat food product to develop egg-like flavors over time. Changes in the flavor can cause the shelf-life to be shortened. As an example, the shelf-life of non-fat milk can ordinarily be a few weeks. Fortifying non-fat milk with polyunsaturated fatty acids using conventional methods can shorten the shelf-life to a few days.

### SUMMARY

According to one embodiment, a food product comprises a non-fat base, one or more polyunsaturated fatty acids, and one or more stabilizing ingredients. The stabilizing ingredients are selected to reduce the rate at which the polyunsaturated fatty acids oxidize in the non-fat base. At least one of the one or more stabilizing ingredients comprises a protein, a lipid, or a protein-and-lipid combination.

Certain embodiments of the present disclosure can provide one or more technical advantages. As an example, in some embodiments, polyunsaturated fatty acids can be fortified into food products for improved nutritional properties. As another example, in some embodiments, the flavor profile of food products fortified with polyunsaturated fatty acids can be substantially maintained and the development of fishy off-notes can be prevented or reduced. As yet another example, in some embodiments, the shelf-life of a food product fortified with polyunsaturated fatty acids can be comparable to that of a similar, unfortified food product. Thus, the shelf-life of a food product fortified with polyunsaturated fatty acids as described in the present disclosure can be substantially longer than the shelf-life of a food product fortified with polyunsaturated fatty acids using conventional methods. For example, non-fat milk fortified with polyunsaturated fatty acids as described in the present disclosure can have a shelf-life similar to that of unfortified non-fat milk (about 60 days) without significant changes in the flavor profile. By contrast, non-fat milk fortified with polyunsaturated fatty acids using conventional methods can have a shelf-life of less than about 7 days due to the off-flavors caused by oxidation of the polyunsaturated fatty acids.

Other technical advantages of the present disclosure will be readily apparent to one skilled in the art from the following figures, descriptions, and claims. Moreover, while specific advantages have been enumerated above, various embodiments can include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example of a system for fortifying non-fat food products with polyunsaturated fatty acids; and

FIG. 2 illustrates an example of a method for fortifying non-fat food products with polyunsaturated fatty acids.

### DETAILED DESCRIPTION

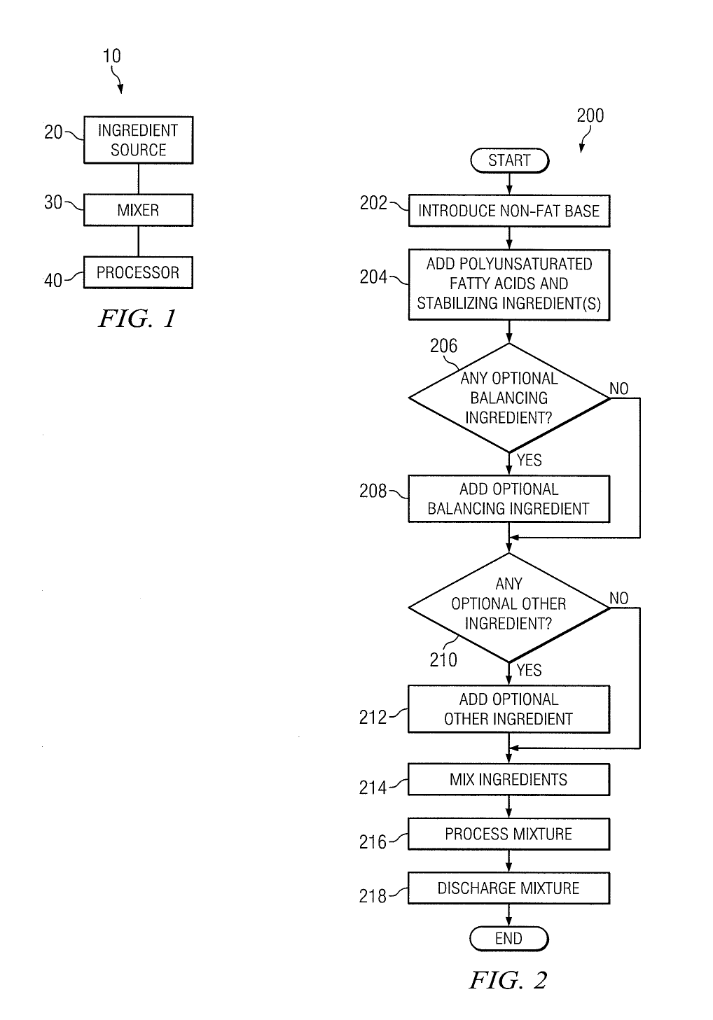

Embodiments of the present invention and its advantages are best understood by referring to FIGS. 1 to 2 of the drawings, like numerals being used for like and corresponding parts of the various drawings.

Polyunsaturated fatty acids (PUFAs) refer to a family of fatty acids that naturally occur in certain fish, leafy green vegetables, and vegetable oils. Polyunsaturated fatty acids can include a carbon chain comprising eighteen or more carbon atoms and two or more double bonds. Examples of polyunsaturated fatty acids include omega fatty acids, such as omega-3 fatty acids (e.g., docosahexaenoic acid (DHA), docosapentaenoic acid (n-3) (DPAn-3), stearidonic acid (SDA), linolenic acid (LNA), and alpha linoleic acid (ALA), and eicosapentaenoic acid (EPA)), and omega-6 fatty acids (e.g., arachidonic acid (ARA), docosapentaenoic acid (n-6) (DPAn-6), linoleic acid (LA), gamma linolenic acid (GLA), and dihomo gamma linolenic acid (n-6)). Research suggests that consuming certain polyunsaturated fatty acids can provide health benefits including possibly lowering the risk of heart disease. Accordingly, polyunsaturated fatty acids can be fortified into food products to impart health benefits. Fortifying certain non-fat food products with polyunsaturated fatty acids can tend to affect the flavor of the non-fat food product over time. For example, fortifying the non-fat food product with DHA or EPA can cause the non-fat food product to develop fish flavors over time, and fortifying the non-fat food product with ARA can cause the non-fat food product to develop egg-like flavors over time. Changes in the flavor can cause the shelf-life to be shortened. As an example, the shelf-life of non-fat milk can ordinarily be a few weeks. Fortifying non-fat milk with polyunsaturated fatty acids using conventional methods can shorten the shelf-life to a few days.

The tendency of food products fortified with polyunsaturated fatty acids to experience flavor changes over time can be caused at least in part by oxidation of the polyunsaturated fatty acids. Certain food products can contain fats suitable to slow the oxidation of added polyunsaturated fatty acids. Fat free or non-fat food products, however, can lack the fats capable of slowing oxidation and can thus be particularly prone to developing fishy off-notes when fortified with polyunsaturated fatty acids. In accordance with the present invention, disadvantages and problems associated with known techniques for fortifying polyunsaturated fatty acids into food products can be reduced or eliminated. For example, certain embodiments can introduce selected proteins or lipids to stabilize the polyunsaturated fatty acids in order to prevent oxidation and to improve the flavor profile and/or shelf-life of the fortified food product.

FIG. 1 illustrates an example of a system 10 for fortifying a food product with polyunsaturated fatty acids. For example, system 10 can fortify fat free or non-fat dairy products including, but not limited to, milk and milk beverages, cultured dairy, cheeses, sour cream, cottage cheese, and yogurt, as well as non-dairy food and beverage products. In some embodiments, fat free or non-fat foods can refer to foods with a fat content less than 0.5 grams per serving. Serving sizes can vary depending on the type of food and, in some embodiments, can be determined from the food label. As an example, a serving of milk is approximately 8 oz in volume (240 ml) and weight of 250 g (specific gravity 1.036 at 4.4° C.). Fat free milk having 0.5 g fat or less in one serving of milk contains approximately 0.2% fat or less (weight of fat on a wet basis).

In some embodiments, system 10 can include one or more ingredient sources 20, a mixer 30, and a processor 40. Ingredient source 20 can introduce ingredients into mixer 30. The ingredients can represent constituent elements that are deposited, mixed, or combined to yield the fortified food product. In some embodiments, the ingredients can include a non-fat base, an polyunsaturated fatty acid, and one or more stabilizing ingredients selected to stabilize the polyunsaturated fatty acid, such as a selected protein and/or a selected lipid. Examples of the non-fat base include a fat free or non-fat milk, a non-dairy base (e.g., soy, cereal, or nut-based ingredients), or a combination. Polyunsaturated fatty acids can include a carbon chain comprising eighteen or more carbon atoms and two or more double bonds. Examples of polyunsaturated fatty acids include omega fatty acids, such as omega-3 fatty acids (e.g., docosahexaenoic acid (DHA), docosapentaenoic acid (n-3) (DPAn-3), stearidonic acid (SDA), linolenic acid (LNA), and alpha linoleic acid (ALA), and eicosapentaenoic acid (EPA)) and omega-6 fatty acids (e.g., arachidonic acid (ARA), docosapentaenoic acid (n-6) (DPAn-6), linoleic acid (LA), gamma linolenic acid (GLA), and dihomo gamma linolenic acid (n-6)). In some embodiments, the polyunsaturated fatty acids can be derived from a marine source, such as fish oil, or a plant source.

The stabilizing ingredient can comprise a selected protein and/or a selected lipid. The selected protein(s) can exhibit hydrophobic properties suitable for balancing protein-lipid interactions and protecting the polyunsaturated fatty acids from oxidation. Examples of suitable proteins include, but are not limited to, milk protein concentrate, whey protein concentrate, soy protein, or a combination. Suitable ingredients, such as certain proteins with an HLB (Hydrophilic-Lipophilic Balance) value in the range of approximately fourteen to five, can have the emulsifying properties to provide an oil-in-water emulsion for the polyunsaturated fatty acids and, therefore, can stabilize the polyunsaturated fatty acids. Examples of selected lipid(s) can include lipid complexes (e.g., buttermilk or buttermilk powder), sunflower oil, soy oil, palm oil, cottonseed oil, other dairy fats, and other vegetable and non-vegetable oils. In fluid milk, for example, the addition of milk-derived lipids can provide a milk fat globule that can function similar to the naturally-occurring butterfat in milk and can protect polyunsaturated fatty acids from oxidization.

In some embodiments, the ingredients can include optional balancing ingredients selected to stabilize the polyunsaturated fatty acids. As an example, optional balancing ingredients can include one or more antioxidants, such as ascorbic acid, sodium ascorbate, BHA, BHT, propyl gallate, and tocopherols. Certain embodiments can include a combination of proteins, lipids, and/or antioxidants to stabilize the polyunsaturated fatty acids.

In some embodiments, the ingredients can include optional other ingredients. Examples of optional other ingredients include, but are not limited to, sweeteners, stabilizers, health supplements, flavors, extracts, coloring agents, salts, functional ingredients, water, and/or other suitable ingredients.

Sweeteners can be added to enhance the taste of the flavorings provided and/or provide overall sweetness to the product. In particular embodiments, sweeteners can include natural sweeteners, artificial sweeteners, or a combination. Examples of natural sweeteners include sugar (e.g., liquid sugar, crystallized sugar, honey, agave, cane juice, etc.) and stevia and its derivatives (e.g., steviol glycosides, rebiana-A, and rebaudioside-A). Examples of artificial sweeteners include sucralose, aspartame, and saccharine.

Stabilizers can enhance physical properties of beverages by imparting viscosity or mouthfeel properties that can increase consumer appeal. Stabilizers can be natural or artificial and can contribute to a uniform appearance of products by stabilizing and or suspending insoluble materials and preventing separation or settling of ingredients. Examples of stabilizers can include, but are not limited to, emulsifiers, starches, and various gums and/or hydrocolloids such as guar, acacia, locust bean, xanthan, gellan, carrageenan, cellulose, and pectin.

Health supplements can enhance the nutritional profile of the food product or provide health benefits. Examples of health supplements include vitamins (e.g., vitamin A, B vitamins, vitamin C, vitamin D, vitamin E, etc.), minerals (e.g., calcium, potassium), herbs (e.g., chamomile, lavender, lemon balm), and probiotics (e.g., yogurt cultures).

Flavors and coloring agents can be added to enhance and/or change the physical properties of the mixture, such as the taste and the visual appearance respectively. Flavors can include vanilla extract, almond extract, citrus extract, cocoa powder, strawberry or other fruit flavoring, or any other appropriate extracts, chemical compounds, or natural additives suitable to change the taste of the mixture.

Salts can be added to improve taste and/or to act as buffering agents to enhance protein stability. Examples of salts include sodium citrate, sodium chloride, potassium citrate, potassium phosphate, and dipotassium phosphate.

Functional ingredients can enhance the functionality of food products and can include plant sterols, bulking agents, such as fiber, or other functional ingredients.

In operation, an operator of system 10 selects appropriate ingredients for the desired finished product. Once appropriate ingredients are selected, the operator introduces the selected ingredients into mixer 30. Ingredients can be added serially (i.e., one at time), collectively (i.e., all ingredients are added substantially at once), or a combination (i.e., certain subsets of ingredients are pre-combined, and the combination is added serially with other ingredients or ingredient combinations). Ingredients can be added in any suitable form, such as a liquid form or a dry-blend.

In some embodiments, mixer 30 can combine the non-fat base with polyunsaturated fatty acids and other ingredients to produce a fortified food product. Mixer 30 can comprise any appropriate container suitable to receive, mix, and/or discharge one or more ingredients. In particular embodiments, mixer 30 can comprise a stainless steel chamber of any suitable size. For example, mixer 30 can be sized to mix the mixture of ingredients in large batches that can later be divided into smaller sizes suitable for sales to consumers, or mixer 30 can be sized to mix smaller, individual-sized portions.

Mixer 30 can receive the non-fat base and the other ingredients through one or more different inlets. For example, the non-fat base can be added to the mixing chamber through one or more nozzle and hose inlets, and the other ingredients, such as polyunsaturated fatty acids, selected proteins and/or lipids, optional balancing ingredients, and/or optional other ingredients, can be added through one or more openings in mixer 30. Mixer 30 can include one or more means for blending, mixing, combining, stirring, and/or agitating ingredients. For example, mixer 30 can include mechanical agitators, pressure jets, or other suitable mixing devices, whether located within mixer 30 or external to mixer 30. Alternatively, mixer 30 can allow for stirring or mixing by hand. In some embodiments, mixer 30 can be chilled (depending on the particular ingredients used) to prevent one or more ingredients from spoiling during mixing and/or processing. Accordingly, mixer 30 can include a jacketed or insulated tank to maintain appropriate temperatures. Mixer 30 can also include one or more discharge outlets connected to other components of system 10. For example, mixer 30 can include one or more discharge outlets connected to hoses or tubes, which can carry an aqueous solution mixed by mixer 30 to processor 40, which can comprise one or more processing components.

After an appropriate mixing time, the food product can be discharged into processor 40 manually or through one or more nozzles, hoses, spigots, or other appropriate discharging outlet. Processor 40 can comprise one or more components for further processing the mixture. As an example, processor 40 can include means for pasteurizing the mixture to reduce the number of undesirable microorganisms and prolong shelf life. As another example, processor 40 can include a homogenizer or other means for reducing particle size so that particle distribution can be maintained and mouthfeel can be improved. Processor 40 can comprise any other components for producing a finished food product. In some embodiments, the finished food product can comprise an polyunsaturated fatty acid-fortified dairy or non-dairy food product.

In some embodiments, the finished food product can be directed from processor 40 to storage or to packaging, bottling, or filling components suitable to ready the finished food product for commercial sale or use. For example, packaging components can deposit an amount of the mixture into one or more bottles, jars, cans, cartons, and/or any other appropriate container.

Modifications, additions, or omissions can be made to system 10 without departing from the scope of the invention. The components of system 10 can be integrated or separated. Moreover, the operations of system 10 can be performed by more, fewer, or other components.

FIG. 2 is a flow diagram illustrating a method 200 for fortifying non-fat food products with polyunsaturated fatty acids. The method begins at step 202 by introducing a non-fat base into a mixer. In some embodiments, the non-fat base can comprise skim milk. In some embodiments, the non-fat base can comprise a non-dairy milk, such as soy milk, rice milk, almond milk, or coconut milk. Non-dairy milk can refer to an aqueous solution comprising an extract, slurry, or other component of a selected base ingredient (e.g., soy beans, rice, almonds, or coconut) mixed with water or other liquid.

At step 204, one or more polyunsaturated fatty acids and one or more selected proteins and/or lipids can be added to the mixture. Examples of selected proteins include milk protein concentrate, whey protein concentrate, soy protein, and proteins having an HLB (Hydrophilic-Lipophilic Balance) value in the range of approximately fourteen to five, which can have the emulsifying properties to provide an oil-in-water emulsion for the polyunsaturated fatty acids and, therefore, can stabilize the polyunsaturated fatty acids. Examples of selected lipids include lipid complexes (e.g., buttermilk or buttermilk powder), sunflower oil, soy oil, palm oil, cottonseed oil, other dairy fats, and other vegetable and non-vegetable oils.

The polyunsaturated fatty acid, the selected protein, and the lipid can be added to the mixture at any suitable time and in any suitable order. In some embodiments, the polyunsaturated fatty acid can be added after the protein and/or the lipid to encourage the ingredients to interact so that the protein and/or lipid binds or clays with the polyunsaturated fatty acid. Claying or binding polyunsaturated fatty acids with protein or lipid can yield a more protective barrier thereby decreasing the susceptibility of the polyunsaturated fatty acids to oxidation.

In some embodiments, using a combination of protein and lipid can yield enhanced binding abilities. Accordingly, the determination whether to add a lipid can be affected by the choice of selected protein. For example, adding a lipid can enhance the binding of milk protein concentrate to yield a selected amount of binding. In general, proteins having higher HLB values can lack adequate hydrophobic properties to suitably bind with the polyunsaturated fatty acids and can benefit when a lipid is added. As an example, in some embodiments buttermilk powder can be used to enhance the oxidative stability of the mixture comprising the selected protein(s). The selected protein(s) tend to adsorb at oil-water interfaces to form stabilizing layers around oil droplets and, thus, are able to act as emulsifiers as well as stabilizers. Buttermilk powder, which is rich in phospholipids content, can further improve the emulsion stability and act as antioxidants to increase oxidative stability of non-fat milk and other dairy products.

Alternatively, the determination whether to add a lipid can be made independently of the protein selection. That is, certain proteins can yield suitable binding without requiring a lipid. Similarly, certain lipids, such as buttermilk, can yield suitable binding without requiring a protein. In some embodiments, the lipid can be added to coat the polyunsaturated fatty acid to protect against oxidation without requiring a protein. In some embodiments, using a lipid to reduce oxidation in a non-fat product, such as skim milk, can be preferable to maintaining naturally occurring fat in the product, such as whole milk. For example, certain vegetable fats can be considered healthier than milk fat.

It can be determined whether to include an optional balancing ingredient at step 206. An optional balancing ingredient can refer to an ingredient that balances the mixture to slow the oxidation of the polyunsaturated fatty acid. As an example, optional balancing ingredients can include antioxidants, such as ascorbic acid, BHA, BHT, propyl gallate, and tocopherols. Antioxidants can prevent and/or reduce oxidation and can preserve the flavor and appearance of the product during refrigerated and/or unrefrigerated storage. In some embodiments, sodium ascorbate or ascorbic acid can be selected to provide vitamin C to the product.

If it is determined to include an optional balancing ingredient at step 206, the method continues to step 208 where the optional balancing ingredient is added. If it is determined not to include an optional balancing ingredient, the method bypasses step 208. The method then proceeds to step 210 to determine whether to include optional other ingredients. Optional other ingredients can include one or more of sweeteners, stabilizers, health supplements, flavors, extracts, coloring agents, salts, functional ingredients, water, and/or other suitable ingredients.

If it is determined to include an optional other ingredient at step 210, the method continues to step 212 where the optional other ingredient is added. If it is determined not to include an optional other ingredient, the method bypasses step 212. The method then proceeds to step 214.

The following TABLE 1 and TABLE 2 illustrate example formulas for a non-fat milk product fortified with polyunsaturated fatty acids. Although certain amounts are described, by weight, ingredients can be increased or decreased to yield the desired properties. In some embodiments, dry ingredients can be pre-blended in a ratio selected to yield a suitable amount of each dry ingredient when the pre-blend is added to the mixture.

TABLE 1

| Ingredient | Approximate Range | Example Range |
|---|---|---|
| Non-Fat Milk | 60-99% | 90-99% |
| Polyunsaturated Fatty | 0.01-2% | 0.1-1% |
| Acid(s) | | |
| Selected Protein(s) or | 0.04-20% | 0.4-3% |
| Lipid(s) | | |
| Balancing Ingredient(s) | 0-18% | 0.1-5% |
| Other Ingredient(s) | Balance | Balance |
| (Optional) | | |

In some embodiments, the amount of the selected protein, if any, can be in the range of 8 to 30 times the amount of polyunsaturated fatty acids. The amount of the selected lipid, if any, can be in the range of 0.8 to 1.25 times the amount of polyunsaturated fatty acids. Any suitable polyunsaturated fatty acid can be used, for example, in some embodiments, the polyunsaturated fatty acid comprises at least approximately 35% (w/w) DHA.

Although TABLE 1 includes examples of ingredient ranges, any suitable amount of each ingredient can be used. For example, lower amounts of polyunsaturated fatty acid can be used, such as less than or equal to approximately 0.001% or less than or equal to approximately 0.0001%. In some embodiments, the mixture can include approximately 1% to 5% stabilizing ingredients (e.g., 1% to 5% lipids, 1% to 5% proteins, or 1% to 5% protein-and-lipid combination) and approximately 0.01% to 5% balancing ingredients (e.g., antioxidant).

TABLE 2

| Ingredient | Approximate Range | Example Range |
|---|---|---|
| Non-Fat Milk | 60-99.9% | 90-99% |
| DHA omega-3 fatty acid | 0.0001-1.0% | 0.001-0.5% |
| Selected Protein(s) | 0.01-10% | 0.1-5% |
| Buttermilk Powder | 0.01-10% | 0.1-3% |
| Other Lipids | 0-1.0% | 0-0.5% |
| Other Ingredient(s) | Balance | Balance |
| (Optional) | | |

At step 214, the mixture can be mixed or combined in any appropriate manner. Mixing can facilitate the dispersion of the ingredients in the mixture as well as the binding between the selected protein or lipid and the polyunsaturated fatty acids. In some embodiments, mechanical agitators, pressure jets, or other suitable mixing devices can be used to stir, mix, blend, agitate, or otherwise combine the ingredients. As another example, the ingredients can be stirred or mixed by hand. Mixing can continue until the ingredients are distributed substantially evenly throughout the product.

The method proceeds to step 216 for further processing. In some embodiments, the mixture can be discharged from the mixing chamber and directed to processing components, such as a pasteurizer and/or a homogenizer. Pasteurization and homogenization can be performed according to conventional methods for the non-fat product. For example, a non-fat milk product can be pasteurized by heating the product and holding it at a selected temperature for a pre-determined amount of time. The temperature and holding time can be selected according to a High Temperature/Short Time (HTST), Extended Shelf Life (ESL), Ultra High Temperature (UHT), or other suitable pasteurization technique.

As another example, the non-fat product can be homogenized. Homogenization can enable the selected protein to reach and interact with the polyunsaturated fatty acids in order to form a stable binding. Any suitable homogenization technique can be used, such as directing the mixture through an orifice at a high pressure to shear the component particles and produce smaller sized particles. Two stage homogenization can be applied in certain embodiments. For example, the first stage can use a pressure in the range of approximately 1000-3000 pounds per square inch (psi), and the second stage can use a pressure in the range of approximately 500-1000 psi. In some embodiments, high pressure homogenization can be applied. High pressure homogenization can use a pressure greater than 10,000 psi, such as at least 20,000 psi.

At step 218, the mixture can be discharged from the system. The finished product can be packaged and stored in refrigerated or unrefrigerated storage. The method then ends.

The method described in FIG. 2 was followed to formulate a number of food products. As an example, a fat free milk was fortified with DHA omega-3 fatty acid, one of the polyunsaturated fatty acids, according to the method of FIG. 2.

The steps illustrated in FIG. 2 can be combined, modified, or deleted where appropriate, and additional steps can also be added to those shown. Additionally, the steps can be performed in any suitable order without departing from the scope of the present disclosure. For example, some or all of the ingredients can be added collectively at a similar time or alternatively ingredients can be added serially at different times. In some embodiments, the optional other ingredients can be added to the non-fat base after the polyunsaturated fatty acids, the protein (if any), and the lipid (if any) so that interactions between the polyunsaturated fatty acids and the stabilizing ingredients can be facilitated. Alternatively, the polyunsaturated fatty acids can be added last, that is, after the protein, lipids, antioxidants, and/or optional ingredients are added. Adding the polyunsaturated fatty acids last allows sufficient time for the protein to hydrate and minimizes the interaction of the polyunsaturated fatty acid in contact with oxygen. In some embodiments, tank blanketing, such as nitrogen blanketing, can be used to minimize the interaction of the polyunsaturated fatty acid and oxygen.

The systems and methods described can include one or more technical advantages. As an example, polyunsaturated fatty acids can be fortified into food products for improved nutritional properties. Such applications include adding DHA omega-3 fatty acid, one of the polyunsaturated fatty acids, into fat free white milk and fat free flavored milks (chocolate, vanilla, strawberry, etc.) to support brain, eye and heart health. Other applications include adding DHA omega-3 fatty acid to fat free cheese products and dairy/non-dairy beverages for the nutritional benefits of DHA omega-3 fatty acid. As another example, in some embodiments, the flavor profile of food products fortified with polyunsaturated fatty acids can be substantially maintained and the development of fishy off-notes can be prevented or reduced. Thus, a fortified non-fat milk product, for example, will maintain a milk flavor similar to that of unfortified non-fat milk. As yet another example, in some embodiments, the shelf-life of a food product fortified with polyunsaturated fatty acids can be comparable to that of a similar, unfortified food product. That is, the flavor, texture, and other properties of the fortified product can be maintained throughout the normal shelf-life for similar, unfortified products (e.g., several weeks for milk). Particular embodiments can provide some, none, or all of these operational benefits, and can provide additional operational benefits.

Although the present disclosure has been described with several embodiments, numerous changes, variations, alterations, transformations, and modifications can be suggested to one skilled in the art, and it is intended that the present disclosure encompass such changes, variations, alterations, transformations, and modifications as fall within the scope of the appended claims.

What is claimed is:

1. A food product, comprising:
a non-fat base;
one or more polyunsaturated fatty acids; and
one or more stabilizing ingredients selected to reduce the rate at which the one or more polyunsaturated fatty acids oxidize in the non-fat base, at least one of the one or more stabilizing ingredients comprising a protein, a lipid, or a protein-and-lipid combination.

2. The food product of claim 1, wherein the non-fat base comprises a dairy milk or a non-dairy milk.

3. The food product of claim 1, wherein at least one of the one or more polyunsaturated fatty acids comprises docosahexaenoic acid (DHA) or eicosapentaenoic acid (EPA).

4. The food product of claim 1, wherein the at least one of the one or more stabilizing ingredients comprises milk protein concentrate, whey protein concentrate, soy protein, or a protein having a hydrophilic lipophilic balance (HLB) value between approximately 14 and 5.

5. The food product of claim 1, further comprising one or more optional balancing ingredients, at least one of the optional balancing ingredient comprising an antioxidant.

6. The food product of claim 1, wherein the at least one of the stabilizing ingredients comprises buttermilk, sunflower oil, soy oil, palm oil, or cottonseed oil.

7. The food product of claim 1, wherein:
the non-fat base comprises 60 to 99% of the food product;
the one or more polyunsaturated fatty acids comprise 0.01 to 2% of the food product; and
the one or more stabilizing ingredients comprise 0.04 to 20% of the food product.

8. The food product of claim 1, wherein the food product comprises a milk beverage, a non-dairy milk beverage, cultured dairy, cheese, sour cream, cottage cheese, or yogurt.

9. The food product of claim 1, wherein a flavor profile and shelf-life of the food product is substantially the same as a flavor profile and shelf-life of an unfortified food product, the unfortified food product substantially free of added polyunsaturated fatty acids.

10. The food product of claim 1, further comprising one or more optional other ingredients selected from the group consisting of sweeteners, stabilizers, health supplements, flavors, extracts, coloring agents, salts, and functional ingredients.

11. A method, comprising:
selecting ingredients comprising a non-fat base, one or more polyunsaturated fatty acids, and one or more stabilizing ingredients selected to reduce the rate at which the one or more polyunsaturated fatty acids oxidize in the non-fat base, at least one of the one or more stabilizing ingredients comprising a protein or a lipid;
introducing the ingredients into a mixing chamber; and
mixing the ingredients to form a mixture.

12. The method of claim 11, wherein introducing the ingredients into the mixing chamber further comprises introducing the polyunsaturated fatty acids after introducing the at least one of the one or more stabilizing ingredients.

13. The method of claim 11, wherein:
the non-fat base comprises a dairy milk or a non-dairy milk;
at least one of the one or more polyunsaturated fatty acids comprises docosahexaenoic acid (DHA) or eicosapentaenoic acid (EPA); and
the at least one of the one or more stabilizing ingredients comprises milk protein concentrate, whey protein concentrate, soy protein, or a protein having a hydrophilic lipophilic balance (HLB) value between approximately 14 and 5.

14. The method of claim 11, further comprising:
selecting one or more optional other ingredients from the group consisting of sweeteners, stabilizers, health supplements, flavors, extracts, coloring agents, salts, and functional ingredients; and
adding the one or more optional ingredients to the mixture.

15. The method of claim 11, further comprising:
selecting an optional balancing ingredient selected to reduce the rate at which the polyunsaturated fatty acid oxidizes in the non-fat base; and
adding the optional balancing ingredient to the mixture.

16. The method of claim 11, wherein:
the at least one of the one or more stabilizing ingredients comprises the protein; and
further comprising:
determining the protein insufficiently binds with the one or more polyunsaturated fatty acids, the determining based on the hydrophobic properties of the protein;
selecting one or more lipids to enhance binding of the protein and the one or more polyunsaturated fatty acids, at least one of the lipids comprising buttermilk, sunflower oil, soy oil, palm oil, or cottonseed oil; and
adding the one or more lipids to the mixture.

17. The method of claim 11, wherein:
the at least one of the one or more stabilizing ingredients comprises the protein; and
further comprising:
determining the protein insufficiently binds with the one or more polyunsaturated fatty acids, the determining based on the hydrophobic properties of the protein;
selecting one or more lipids to enhance binding of the protein and the one or more polyunsaturated fatty acids; and
adding the one or more lipids to the mixture;
wherein the non-fat base comprises approximately 90 to 99% of the food product, the one or more polyunsaturated fatty acids comprise approximately 0.1 to 1% of the food product, the protein present in an amount approximately 8 to 30 times the amount of the one or more polyunsaturated fatty acids, and the one or more lipids present in an amount approximately 0.8 to 1.25 times the amount of the one or more polyunsaturated fatty acids.

18. The method of claim 11, further comprising homogenizing the mixture using two stages, wherein the two stages comprise a first stage using pressure in the range of approximately 1000 to 3000 pounds per square inch and a second stage using pressure in the range of approximately 500 to 1000 pounds per square inch.

19. The method of claim 11, preparing a food product from the mixture, the food product comprising a milk beverage, a non-dairy milk beverage, cultured dairy, cheese, sour cream, cottage cheese, or yogurt.

20. The method of claim 11, preparing a food product from the mixture, wherein a flavor profile and shelf-life of the food product is substantially the same as a flavor profile and shelf-life of an unfortified food product, the unfortified food product substantially free of added polyunsaturated fatty acids.
